(19) United States
(12) Patent Application Publication
(10) Pub. No.: US 2006/0166173 A1
(43) Pub. Date: Jul. 27, 2006

(54) Educational method and device

(76) Inventors: Michael B. Ellis, Keller, TX (US); Edward M. Kost, Sacramento, CA (US); Jan M. Wasowicz, Evanston, IL (US)

Correspondence Address: Lynn E. Barber, P.O. Box 16528, Fort Worth, TX, 76162, US

(21) Appl. No.: 11/044,088

(22) Filed: Jan. 27, 2005

(51) Int. Cl. G09B 19/04

(52) U.S. Cl. 434/185; 434/317

(57) ABSTRACT

A teaching apparatus for students, having a lab unit with a top face, a plurality of manipulable indicator tiles, each tile having a character printing area containing an indication mark and having an identifier chip; tile-reader pockets on the top face; a touch screen and stylus; and a liquid crystal display screen, so that the lab unit can scan and recognize an identifier chip in an indicator tile placed in a tile-reader pocket and the lab unit can teach and assess through means of the speakers and graphic panel/touch screen.

### BACKGROUND OF THE INVENTION

Field of the Invention

This invention relates to an educational device and methods for improving students' skills in various subjects, and in particular, to a device and methods in which a unique hardware/software platform, including an LCD panel, touch screen, speakers and alpha-numeric labeled tiles, delivers (via wireless radio) tailored, sequential, multi-sensory instruction for students in subjects such as reading, writing, spelling and math.

Introduction

Students arriving in kindergarten exhibit a huge range in skills necessary to become good readers and mathematicians. The typical classroom has students ranging in ability from those of three year olds to those of eight year olds. While dealing with such disparate abilities, teachers must also contend with heavy content requirements and tight time constraints. They are thus forced to “teach to the middle” of their classes' ability range, often leaving unmet the needs of students on both ends of the spectrum. Complicating matters further, the abilities, backgrounds and experience levels of the teachers themselves vary widely.

With specific regard to the teaching of reading, it has moreover only recently become clear to researchers that early readers must be trained in phonological awareness before phonics can be mastered. To counter the wide range of issues clamoring for teachers' attention and ensure that kindergarten and first grade reading students receive similar instruction on essential fundamentals, many major metropolitan school districts have adopted “direct instruction” programs. These widely-purchased literacy programs require teachers to read, verbatim, written lessons from manuals to the students each day. After that group instruction, the teachers are then expected to draw to themselves smaller clusters of approximately six similarly-skilled students to work more closely with their individual needs.

The small-group time is, of course, invaluable. Unfortunately, while the teacher is working with a cluster, the rest of the students in the classroom rarely have anything challenging enough to capture their attention, let alone really instruct them. This results in frustration and disruptive behavior of the unengaged students.

Currently, computer software designers have stepped into the gap, producing programs focusing on ear training, phonemic awareness, phonics, etc., and have met with some success. Often, the students not working in small groups with the teacher will rotate through the 2 to 4 computers assigned to such classrooms. But significant problems associated with computer use have also been found among early readers.

For one thing, the best software available is usually internet-delivered, which is often expensive to acquire and difficult to maintain. And, of course, since touch screen computers are extremely expensive and not generally available, students usually have a “mouse” as the only means to express their all-important output. But young students using standard computers are simply not very attracted to working with a mouse and tend to loose attention rather quickly.

Finally, monitor screens are very large and students are easily embarrassed that others nearby can see their work. Other technology-related solutions in the early reading field are similarly problematic, with defects either in delivery, content or both.

Description of the Related Art

There are many patents for computerized educational assistance. For example, it is known to utilize synthesized voice sounds in response to touch on a device (Wood U.S. Pat. Nos. 5,188,533 and 5,511,980; Hyman U.S. Pat. No. 5,495,557). Such devices have also utilized a touch pen (Ohara 5,739,814), wireless communication with another unit (Cutler 5,842,871; Zalewski 5,991,693), movable elements over electrical elements (e.g., switches)(Wood, 6,641,401), radio frequency signal generators (Ernst US2004/0043371), and use of RFID to identify device users (Weston US2004/00923 11).

The educational device of Marcus utilizes blocks capable of outputting a character identification signal that uniquely represents the character indicated on the upper surface of the block, and a working platform which generates character identification information for a block based on the character identification signal output from that block and also to generate location information indicating the location of a block relative to other blocks on the working platform (U.S. Pat. No. 6,729,881; 6,739,874; and 6,755,655 and U.S. patent application No. US2004/0219495).

Patents granted to Wasowicz, (U.S. Pat. No. 6,755,657; 6,585,517; 6,511,324; 6,435,877; 6,146,147), and to Wasowicz, et al., (U.S. Pat. No. 6,299,452) utilize software designed to run on standard computers to improve phonological awareness, phonological processing and reading skills. Other patents demonstrating prior art include U.S. Pat. No. 6,669,479 a method and apparatus for improved visual presentation of objects for visual processing; U.S. Pat. No. 6,629,844, a method and apparatus for training of cognitive and memory systems in humans; U.S. Pat. No. 6,599,129, a method for adaptive training of short term memory and auditory/visual discrimination within a computer game; U.S. Pat. No. 6,565,359, remote computer-implemented methods for cognitive and perceptual testing; U.S. Pat. Nos. 6,457,362, 6,349,598 and 6,109,107, methods and apparatus for diagnosing and remediating language-based learning impairments; U.S. Pat. No. 6,409,685, a method for improving motor control in an individual by sensory training; U.S. Pat. No. 6,334,776, a method and apparatus for training of auditory/visual discrimination using target and distractor phonemes/graphemes; and U.S. Pat. No. 5,957,699, a remote computer-assisted professionally supervised teaching system.

The Device

The invention herein combines a unique hardware/software device which delivers sequential instruction tailored to each student involving unique teaching methods. The literacy-related version of the unit is based on the most recent early-reading research, combining ear training and phonemic awareness modules, as well as explicit phonics instruction, writing and spelling lessons, plus fluency and vocabulary development activities.

Further, because the invention software can differentiate between students, each can move at their own rate through the linear sequence of lessons, whether using the math or literacy-related versions. Additionally, the students can take the device of the invention to their own desk and study without any other student able to see their work. The device is even able to deliver animation on-screen which is, of course, riveting to students.

Moreover, the ability to literally “build” words or (even math equations with the lab version built for arithmetic) with the unit's manipulatable tiles, provides an absolutely unique opportunity for students. For example, recent research shows that to become a successful reader it is imperative that beginners develop perfect mental images of correctly spelled words, precisely the type of experience provided students using the unique hardware and unique teaching methods revealed below.

In addition, the device of the invention has touch-screen capabilities (including the use of a stylus) providing excellent input/output opportunities for students learning reading, spelling, writing or math skills. And since it stays in wireless, constant contact with the much larger memory capabilities of the teacher's personal “host” computer, it can deliver sequential instruction, even though the unit's own memory is comparatively small. Finally, because it remains in constant contact with the host computer, the device of the invention is able both to track a student's progress and to provide the teacher with accurate progress and even grouping reports.

Thus, the device and methods of the invention involve a unique hardware/software platform, which delivers sequential instruction tailored to each student composed of unique, multi-sensory teaching methods. Other objects and advantages will be more fully apparent from the following disclosure and appended claims.

### SUMMARY OF THE INVENTION

The invention herein is a teaching apparatus for students, comprising: a unit known as the Lab 32, which opens like a book, displaying on the right side a top face that includes a liquid crystal display (LCD) panel 40, a touch screen 39, at least one speaker 12, a wireless local area network (WLAN) radio with transceiver as is known in the art and not shown (See FIG. 4 for wireless network transceiver location 37), manipulatable indicator tiles 6,33 (each tile having both a face containing an external indication mark as well as a unique internal identification transmission signal related to the particular indication mark on the face of the tile), and pockets 16 in which to place the tiles 6,33 to form words or numbers, each pocket containing an RFID circuit board 52 including a transmission signal receiver as is known in the art and not shown.

Other objects and features of the inventions will be more fully apparent from the following disclosure and appended claims.

### BRIEF DESCRIPTION OF THE DRAWINGS

FIG. 1 is a schematic view of a first preferred embodiment of the lab unit of the invention .

FIG. 1a is a schematic view of an alternative embodiment of the lab unit invention for teaching arithmetic.

FIG. 2 is a top plan view of the device of the invention showing the right-half of the lab unit, showing the screen, tile-reader pockets, and storage bins.

FIG. 2a is a top plan view of the device of the invention showing the right half of the arithmetic version.

FIG. 2b is a top plan view of an alternative embodiment of the invention (“keyboard version”) for older students, the right half substituting a keyboard in place of letter tiles, speakers, LCD screen and handle.

FIG. 2c is a section view of one key of the keyboard and part of the surrounding device as shown in FIG. 2b. FIG. 2c shows the Lab housing, a key cap, elastomer key switch, light pipe illumination and circuit board.

FIG. 3 is a top plan view of the lab unit of the invention showing the left half of the device, presenting the ID reader, stylus with lanyard, RFID location and handle.

FIG. 4 is a bottom plan view of the lab unit of the invention, showing possible locations for the charging coil, wireless network transceiver and microcontroller.

FIG. 5 is a side elevational view of the lab unit of the invention.

FIG. 6 is a front elevational view of the lab unit of the invention.

FIG. 7 is a side-schematic view showing the LCD screen and the touch screen

FIG. 8 is a perspective view of a manipulatable tile of the invention.

FIG. 9 is a cross-section of a manipulatable tile of the invention showing placement of RFID technology.

FIG. 10 is a perspective view of the lab unit showing the tile storage bins.

FIG. 11 is a detailed partial perspective view of a tile-reader pocket and tile bins for placement of manipulative tiles.

FIG. 12 is a cross-section of a tile-reader pocket showing placement of RFID receiver technology.

FIG. 13 is a bottom perspective view of an ID tag according to the invention with a mating component that may be used for all tag shapes.

FIG. 13a is a top perspective view of a possible ID tag according to the invention.

FIG. 14 is a perspective view of a classroom storage tower of the invention.

FIG. 14a is a perspective view of a tower charging pad

FIG. 15 is a flow-chart of typical use of the invention.

### DETAILED DESCRIPTION OF THE INVENTION AND PREFERRED EMBODIMENTS THEREOF

The present invention comprises a unique educational device presenting sequential instruction tailored to individual students, using unique multi-sensory teaching methods to educate students in literacy and math skills. It is understood of course, that people other than children who do not know how to read, write or cipher may also benefit from use of the invention herein. Further, it is also understood that subjects other than reading, spelling, writing and math may be taught using the invention and its methods of instruction.

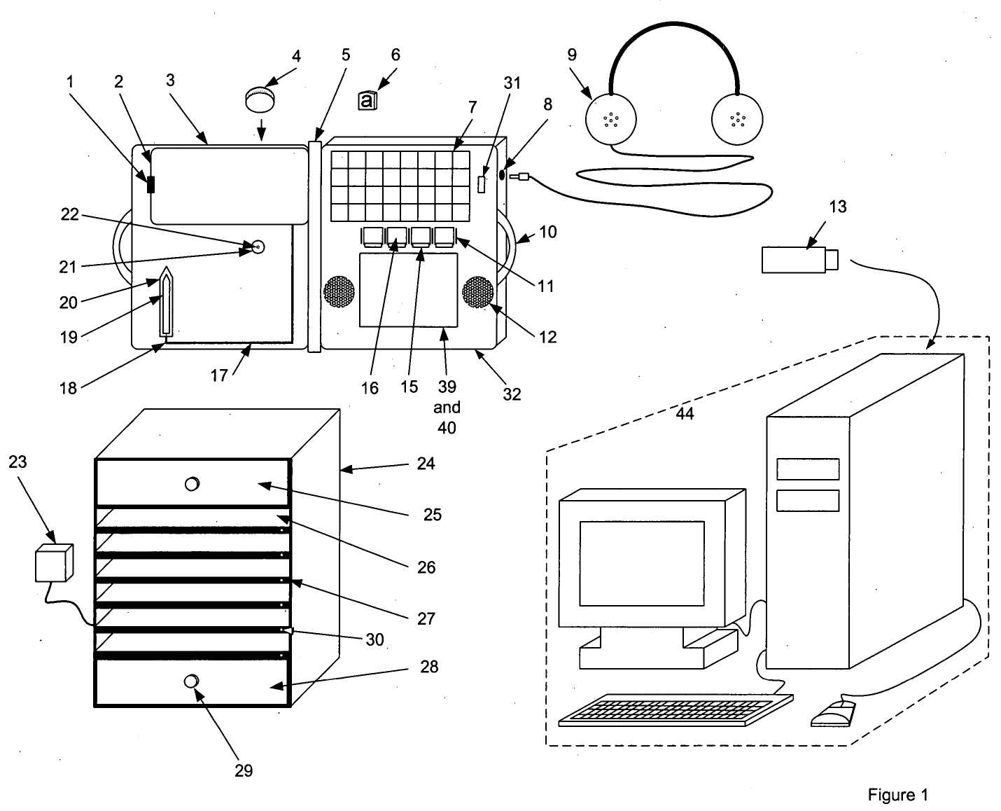

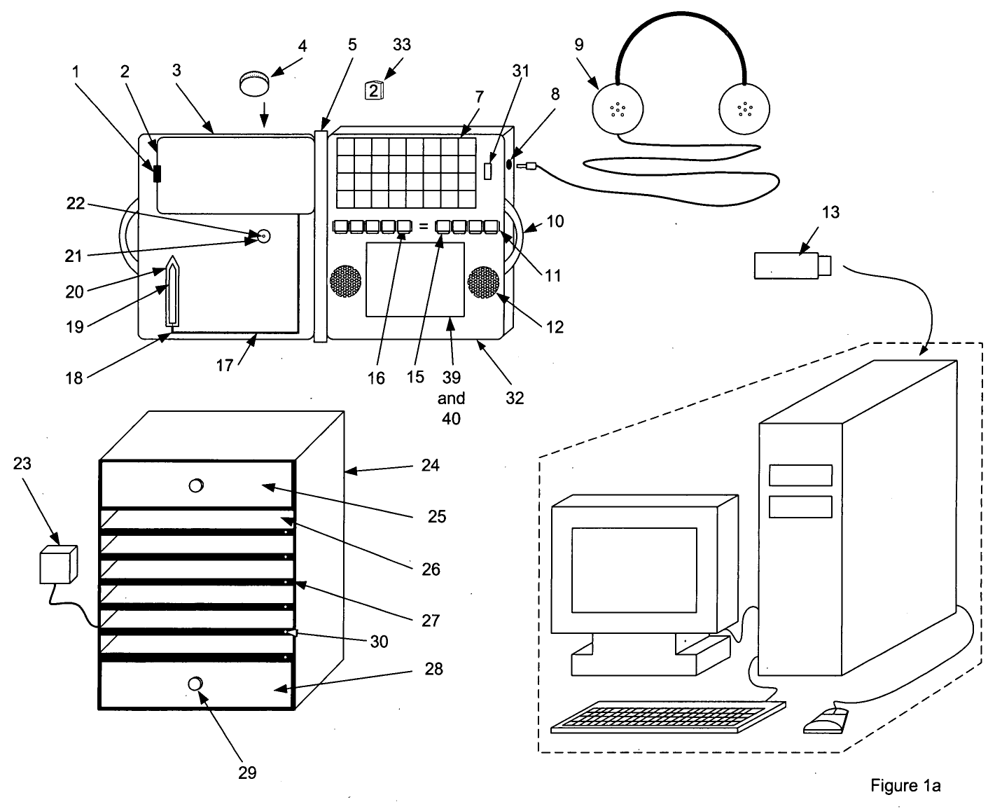

Referring now to the figures, the assembled components of the invention are shown in FIG. 1, and are discussed in detail below. The centerpiece of the educational device of the invention comprises a unit to teach reading or math skills. The lab unit used to teach language/literacy skills is called a Literacy Laboratory (“LitLab”, or variously “Lab”) while the lab unit used to teach and reinforce arithmetic skills is called a “Quantum Lab” (FIG. 1a). The LitLab provides lettered tiles 6 for manipulative learning while the Quantum Lab provides arabic-number tiles 33 instead. Also, twelve variously colored tiles without any printed figures are provided as place holders for certain ear-training exercises in the LitLab discussed below.

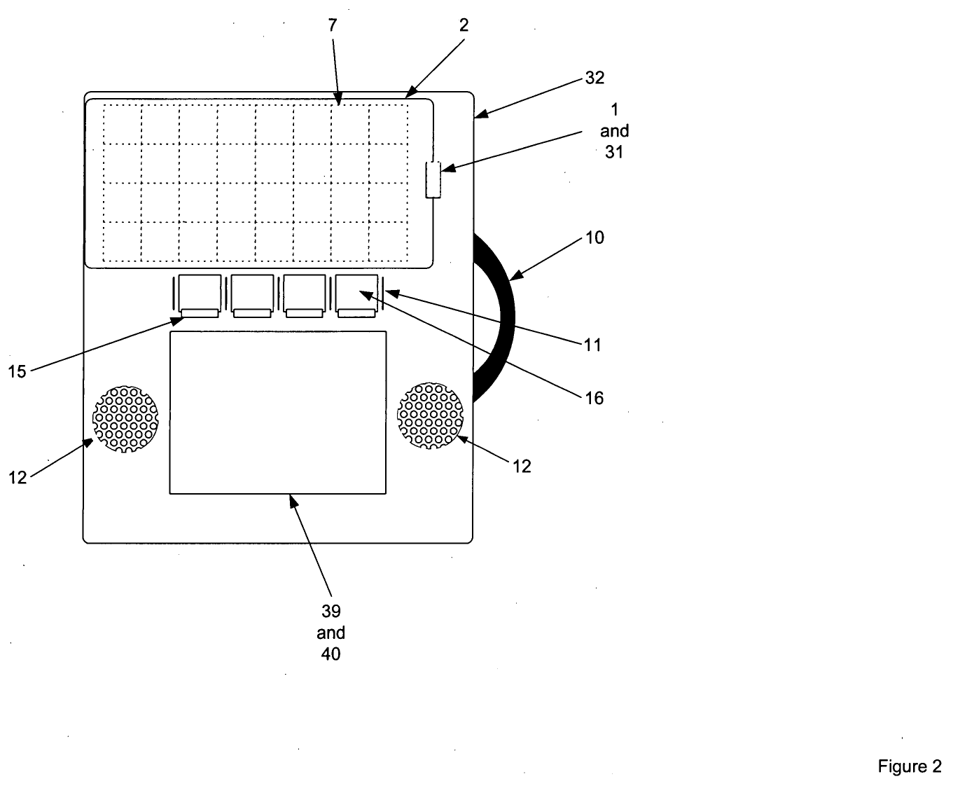

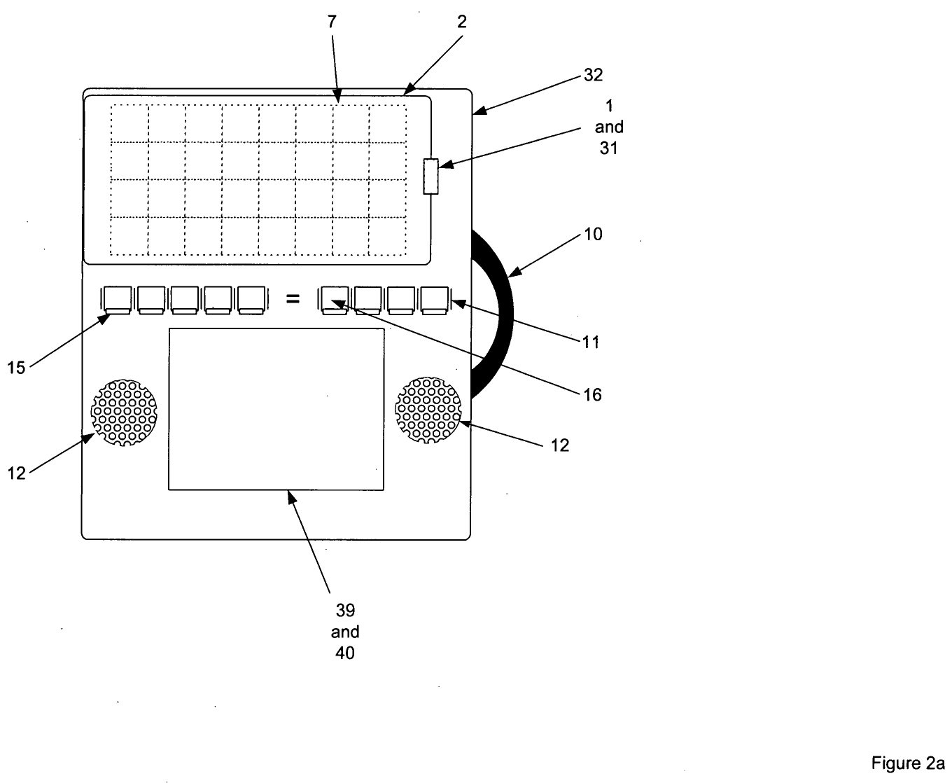

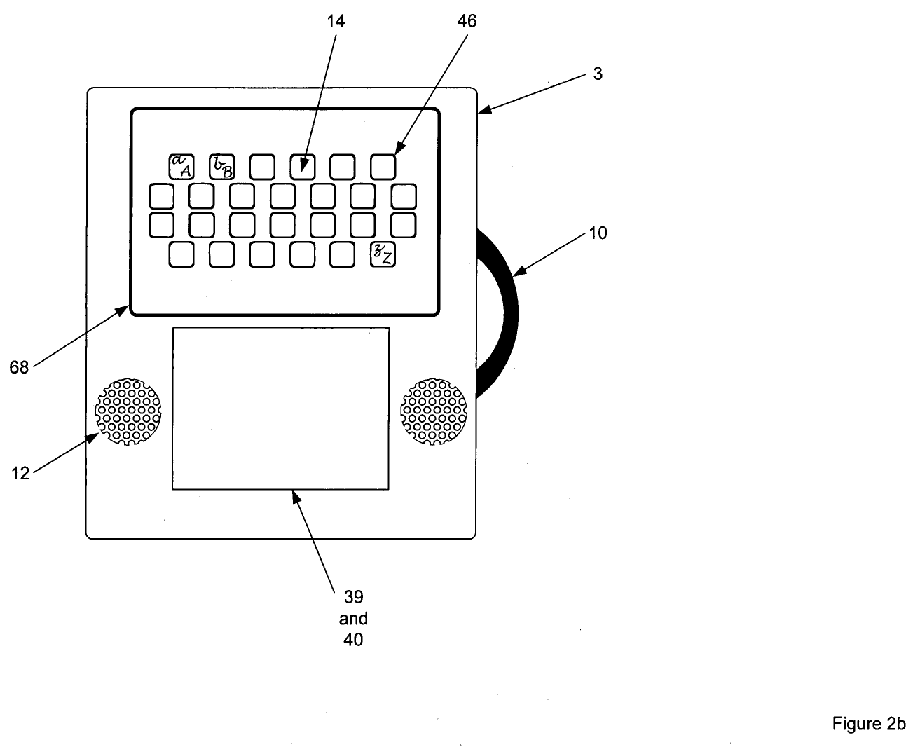

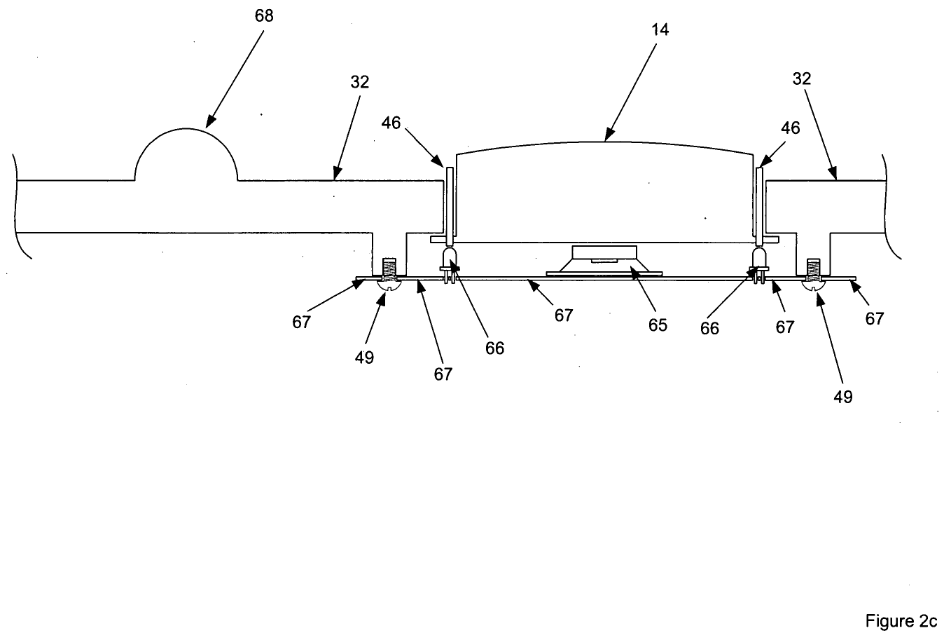

In either primary embodiment of the invention, the lab unit is preferably constructed primarily out of injection-molded plastic, having the shape of a large book, i.e. a rectangle 13.5″ by 14.25″ by 1.6″ thick. (See FIG. 1). The unit has two halves, (FIGS. 2 & 3), the left serving primarily as a protective lab cover 3 to the LCD panel 40 in the right half.

A large hinge 5 couples the two halves of the lab. A handle 10 is molded onto each half of the “book” opposite the hinge and both handle-halves mate upon closing, as is known in the art, to form a secure grip for carrying the lab unit. The user opens the lab unit as he would a large child's book, laying both halves out flat against a table surface with each half resting on several rubber feet 35 for stability. Upon opening, the following is revealed:

I. The Right Half of the Lab Unit

A. Liquid Crystal Display (“LCD” panel) 40

1. LCD Function.

Looking at the right half of the opened lab unit and closest to the user, the user sees a graphic LCD panel 40 as is known in the art, capable of presenting black and white pictures, letters or numbers and even simple animation.

2. LCD description/construction.

The LCD panel 40 in the preferred embodiment is a reflective Film-compensated Super Twisted Nematic (“FSTN”) type panel, 320 pixels wide by 240 pixels high. It has a six inch diagonal dimension and a 4:3 aspect ratio. As the panel is reflective, no backlight is required and its brightness depends on ambient lighting. It is attached to the frame of the unit by LCD mounting screws 41. In other embodiments, the screen may be larger, it may be in color or there may be multiple screens.

B. Touch Screen 39

The LCD panel 40 is topped by a touch screen 39, as is known in the art, allowing users to simulate drawing on the LCD panel 40 while using a specially designed stylus 19. The touch screen 39 is attached to the LCD panel 40 frame by double-sided adhesive tape. It is a glass and plastic laminate with the plastic side facing out with transparent conductive films deposited on the inside surfaces of the glass and plastic film. Small bumps are formed on the inside of the plastic film that keeps the plastic film from touching the glass, unless a stylus is pressed against the outside of the plastic film. A voltage is applied to the two film layers and when the stylus forces the film layers in contact with each other, by flexing the out plastic film, a circuit is formed and because of the resistive characteristics of the films, a voltage divider is formed and the stylus position can be determined from these voltages. The touch screen has an outer surface treatment on the plastic film that diffuses bright light reflections and another treatment that reduces the accumulation of fingerprint smudge. The bumps on the inside of the plastic film are sized and pitched such that the panel will note easily respond to finger touches or the user's palm resting on the screen.

C. Speakers 12

1. Speaker function.

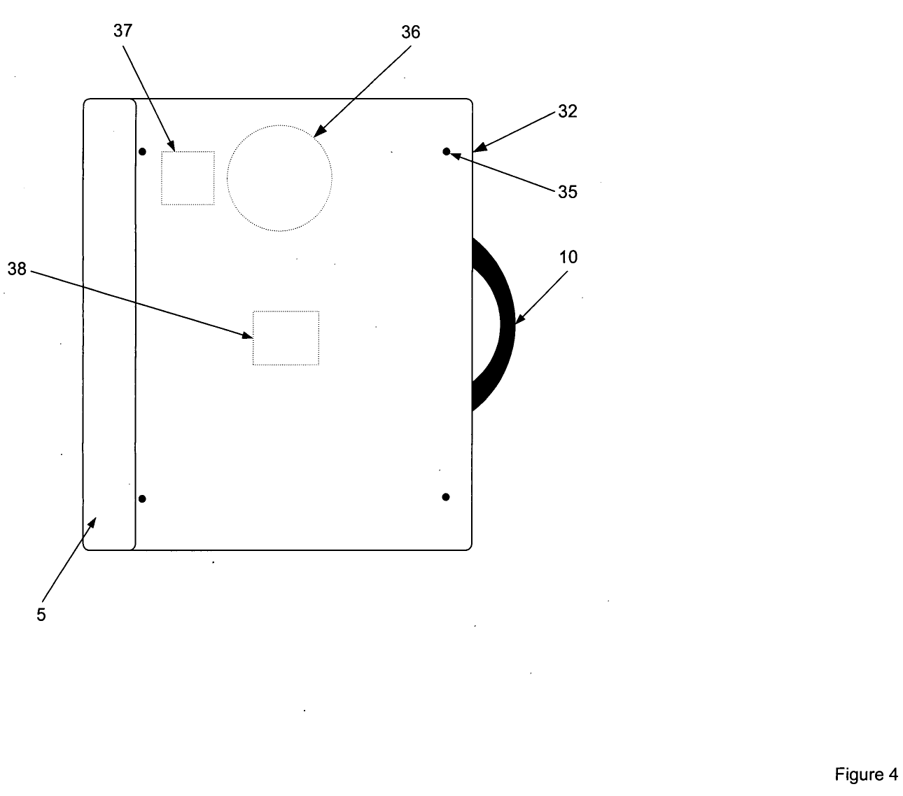

Located on each side of the LCD panel 40 are speakers 12 through which the user is directed by the software. When the device programming has determined that the speakers 12 must play a sound, (or sound is sent through the headphones 9), the microcontroller programming makes a request of the teacher's host computer through the WLAN network for the specific sound file. The sound file is a compressed binary representation of the required sound. The microcontroller (as is known in the art and not shown; see FIG. 4 for location 38) in the unit directs the sound file to another piece of microcontroller programming that converts the binary data into a continuously varying pulse width modulated (“PWM”) signal that is filtered and then amplified to drive the speakers 12 and headphones 9.

2. Speaker description.

The speakers 12 as are known in the art and not shown are preferably standard off-the-shelf 30-50 mm diameter, 8-ohm paper cone permanent magnet speakers.

D. Headphone 9

1. Headphone function. Stereo headphones 9 are provided for minimizing distractions.

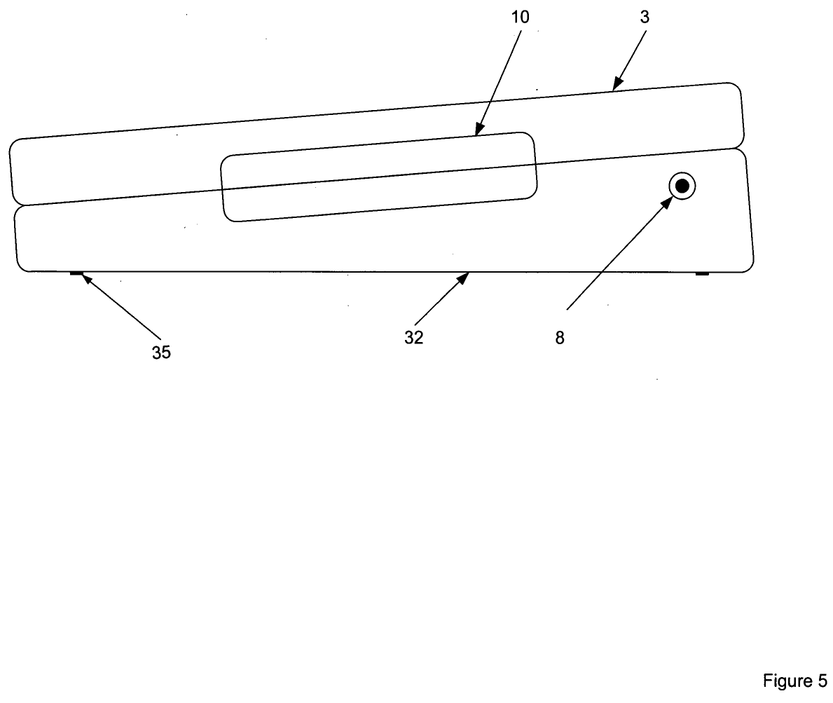

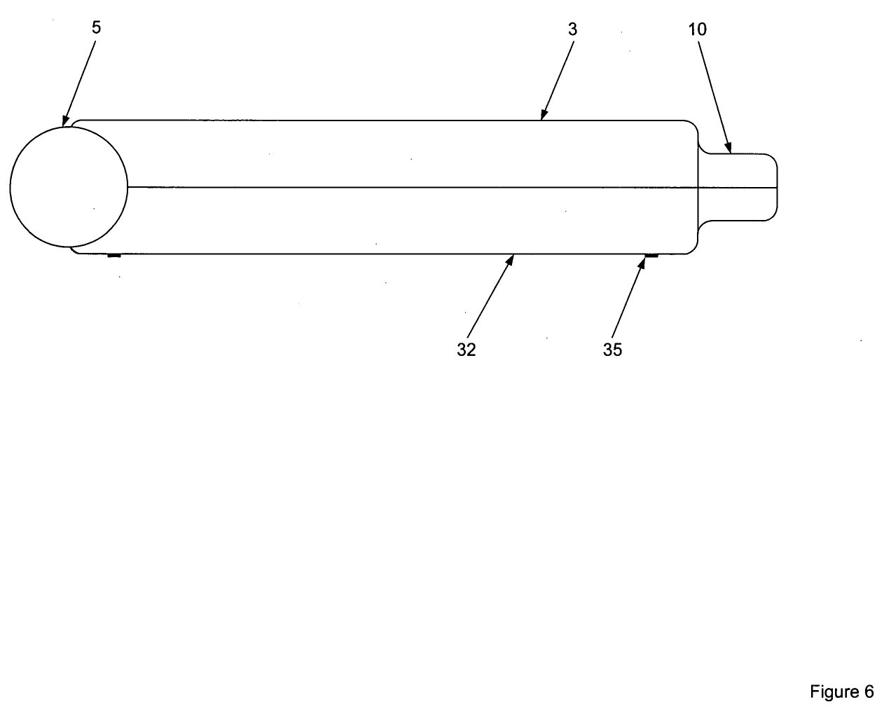

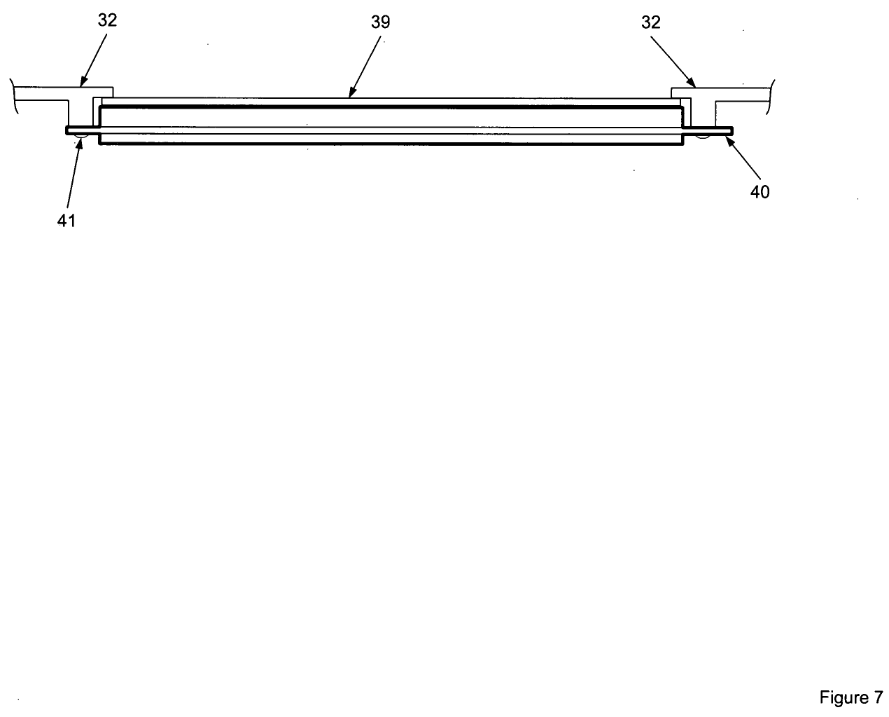

2. Headphone description/construction. The headphones 9 are standard off-the-shelf models. The headphone jack 8 is shown along the right-hand edge of the unit. (See FIG. 5.)

E. Letter Tiles 6

Also on the right-hand side, but at the top of the “page” furthest away from the user when in use, is a plastic tile bin cover 2 seated above the tile bins 7 where the tiles 6 are stored. When the tile bin cover latch 1 mates with the tile bin cover latch receptacle 31, the fifty-two letter tiles 6 and twelve unlabeled colored tiles in the LitLab's tile storage bins 7 are prevented from falling out of the unit (FIGS. 1 & 10). When the tile bin cover 2 is opened via the hinge 5 to allow access to the tile storage bins 7, it swings back into the tile bin cover pocket 47.

In some versions of the Lab, there are thirty-two tile storage bins 7 for storage in some versions, each a bit wider than the 1.0-inch-wide tiles, and capable of holding two tiles 6,33 leaned next to one another. (The LitLab provides at least two tiles of each alphabet letter tiles 6 and at least two each of six variously colored tiles unshown. The latter are used as place-holders in a certain ear-training teaching method.)

The tile storage bins 7 are molded so that when the tiles 6,33 are placed for storage they appear to lean approximately forty (40) degrees off vertical, away from the user, allowing easy viewing of the graphics on the tile surfaces and easy access for removal.

1. Tile 6 function

As described in more detail below, the tiles 6 may be used in a unique “Tile Teaching Method”. Generally, the user selects tiles and builds words or math equations, either at the direction of the Lab 32 or of his own choice. In the literacy-related unit, when a tile is placed in one of the tile-reader pockets 16, the Lab 32 can scan and recognize the identifier microchip in the tile, then assist the student to build correctly-spelled words of various lengths. When a word is correctly spelled, the Lab 32 preferably flashes green LED's 50 lining the base of the pockets as a reward.

2. Tile 6,33 description/construction.

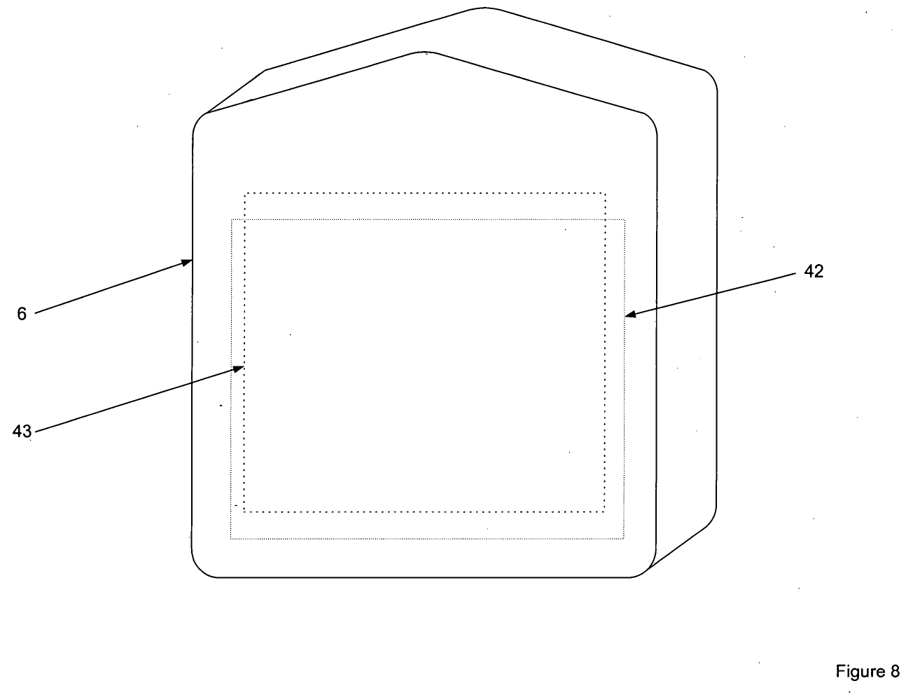

Each tile is manufactured of molded plastic and each is approximately 1 inch square and about 0.5″ high, with rounded edges (See FIG. 8). Each letter tile has a lower case alphabet letter printed on one side in the character printing area 43. The term “indication mark” is used herein to include the letter, number or other indication such as a color or other mark that is placed on the tile character printing area 43. In some versions of the LitLab 32, two tiles 6 are provided for each letter of the alphabet. Variously colored tiles without graphics printed on their face (See FIG. 8) are also included to be used in the teaching methods stated below. Thus a total of sixty-four tiles are provided in some versions of the literacy-related unit. One of the four edges of each tile 6,33 (the side directly above the printed symbol), has a raised, roof-like appearance to assist students to easily grasp it from its bin while providing a hint as to how to keep it in an upright position (FIG. 8.). Inside each tile is one-half of the Radio Frequency Identification system (RFID circuit board 42) constructed as is known in the art.

F. Tile-reader Pockets 16

1. Pocket function.

Located immediately above the LCD panel 40 is an area containing molded tile-reader pockets 16 into which the letter tiles 6,33 can be placed and “read” by the RFID system with the lab unit's software (FIG. 1). The pockets 16 are placed in close proximity to the LCD panel 40 to allow it to provide visual graphic support when the pockets 16 are being used.

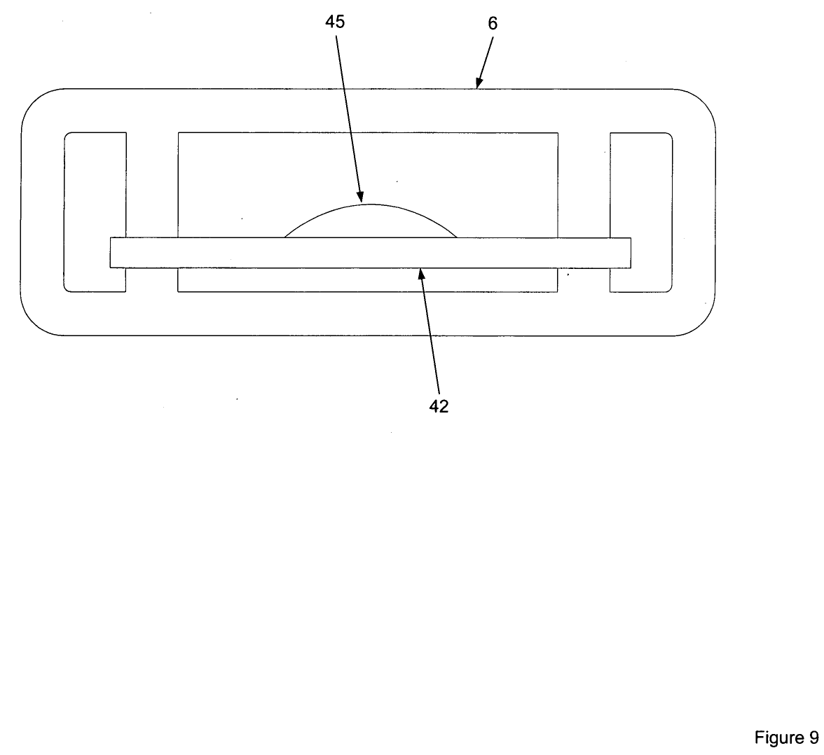

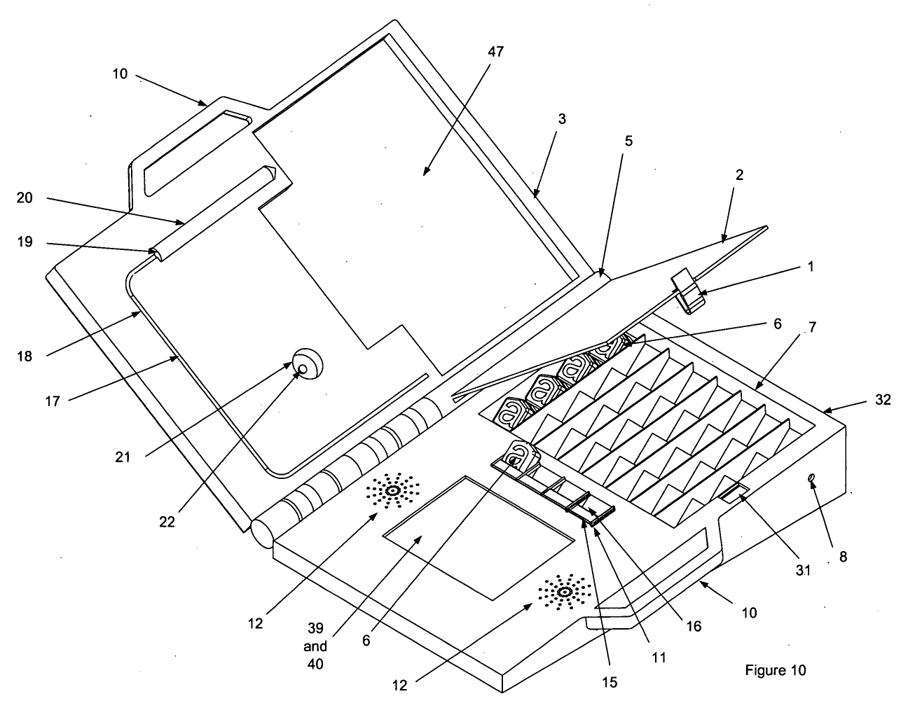

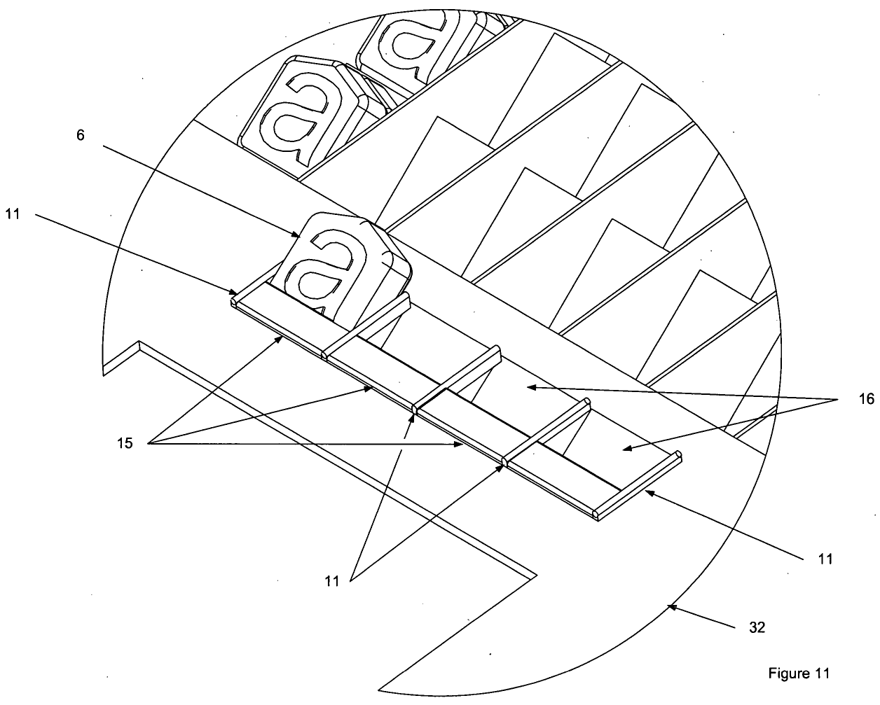

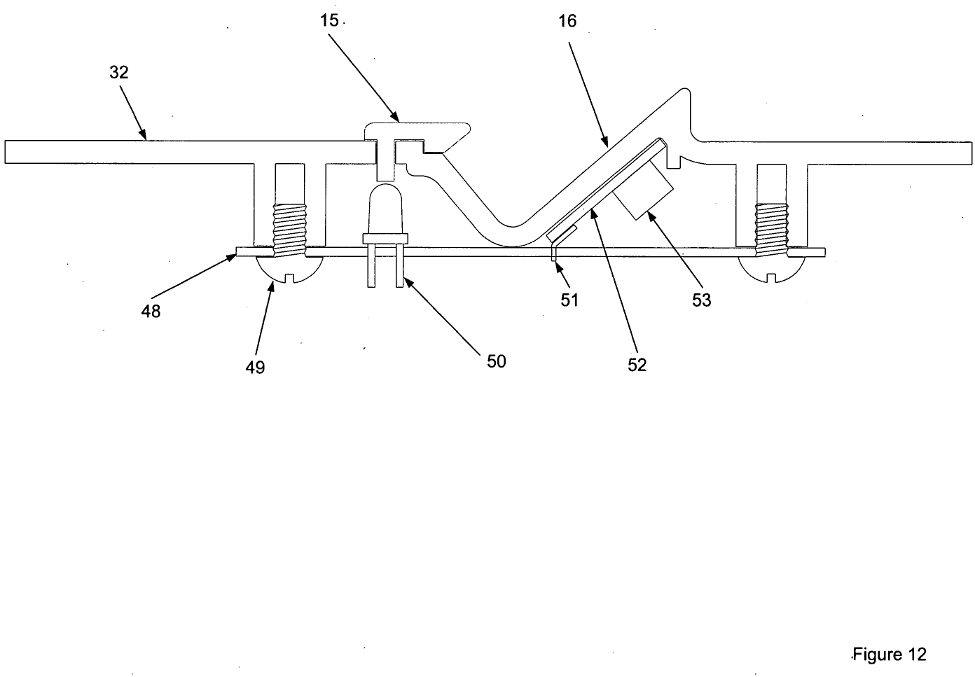

The pockets 16 are each independent, both physically and electrically from each other. When a tile 6,33 is placed into a pocket 16 it is held up by the pocket 16 facing the user at an angle several degrees off of horizontal. As shown in FIG. 12, immediately behind the plastic forming the surface upon which the tile 6,33 rests, is a small RFID circuit board 52 containing the RFID receiver as is known in the art and not shown. The RFID circuit board 52 is less than 1 inch square and contains the RFID receiver integrated circuit as is known in the art (not shown). This receiver is constantly radiating a 13.56 MHz magnetic field from a tank coil 53 composed of a small, unshielded ferrite bobbin inductor and a capacitor, as known in the art (not shown). The receiver radiation induces a current in another tank in the tile 6,33 consisting of a coil etched on the RFID circuit board 42 and a capacitor, as are known in the art and not shown (FIG. 9) The RFID integrated circuit within the tile converts this current into the power necessary to operate and then re-radiates some serial data unique to that tile 6,33.

The circuit board 42 within the tile 6,33 is less than 0.75 inches square and contains the RFID tag integrated chip 45. The receiver integrated circuit receives this serial data and transmits it to the microcontroller (as is known in the art and not shown, although microcontroller location 38 is shown in FIG. 4) through one of its general-purpose input/output ports configured as an asynchronous serial port. Through the microcontroller programming, the tile 6,33 identification and pocket 16 location is then known.

If the Lab 32 is instructing a student to select a particular tile 6,33, the unit illuminates red pocket illumination bars 11 on either side of a particular pocket 16 to give the student direction where to place the tile 6,33. For example, if the student is building the word “cat”, while the student is selecting the tile 6 with the letter “c” printed on it, the unit illuminates the pocket illumination bars 11 on each side of the left-most pocket 16, to inform the student to place the tile 6 there.

After the student has correctly placed a letter tile 6,33 in a pocket 16, the Lab 32 illuminates the green pocket illumination retainer 15 directly in front of the pocket 16 to indicate to the student he/she is on the correct path to building a word. Each of the green retainers 15 are molded out of clear or green translucent plastic and are held in position by either heat staking or hardware (not shown) on the inside of the Lab. The green pocket illumination retainers 15 also have the function of keeping the tiles 6,33 restrained within the pocket and reducing the likelihood of the tiles 6,33 being accidentally dislodged from the pockets 16. The pocket illumination retainers 15 are preferably illuminated by green light emitting diodes (“LED's”) 50 located on the circuit board 48 directly under the pocket illumination retainers 15. The circuit board 48 is attached by the board mounting screws 49. A jumper wire 51 attaches the RFID receiver board 52 to the main circuit board 48.

As in the example above, when a student who is attempting to spell the word “cat” places a “c” tile 6 in the first pocket 16 then an “a” tile 6 in the second pocket 16, the green pocket illumination retainers 15 under both the first and second pockets 16 remain illuminated. When a student correctly spells a word, the lab unit flashes the pocket illumination retainers 15 under all the letter tiles 6 forming a completed word as a reward.

2. Tile-reader pocket 16 description/construction.

The preferred RFID system, which is used to identify the letter tiles 6,33 is made by Sino Matrix Technology, Inc. 3F-5, 371, Sec. 1, Kwang-Fu Rd., Hsinchu City 300, Taiwan, R.O.C. 886-3-564-0786. The receiver (unshown but known in the art) on the RFID Circuit Board 52 part number is HL5233. The tag chip 45 part number is HL5230.

G. Integrated Keyboard version

In versions of the unit made for older students, an integrated keyboard is substituted for the letter tiles 6 (FIG. 2b). Each letter of the alphabet is assigned its own key cap 14 which when depressed makes a connection in the elastomer switch 65. An LED 66 provides the software ability to light a particular key cap via the key light frame (light pipe) 46 in order to draw attention to each key as needed. Each key is mounted on the key circuit board 67 and all the keys are provided some minimal protection against large objects falling across them by the key cap protector 68, a thin ridge of molded plastic surrounding the entire keyboard and raised just above the surface of the key caps 14.

II. The Left Half of the Lab Unit

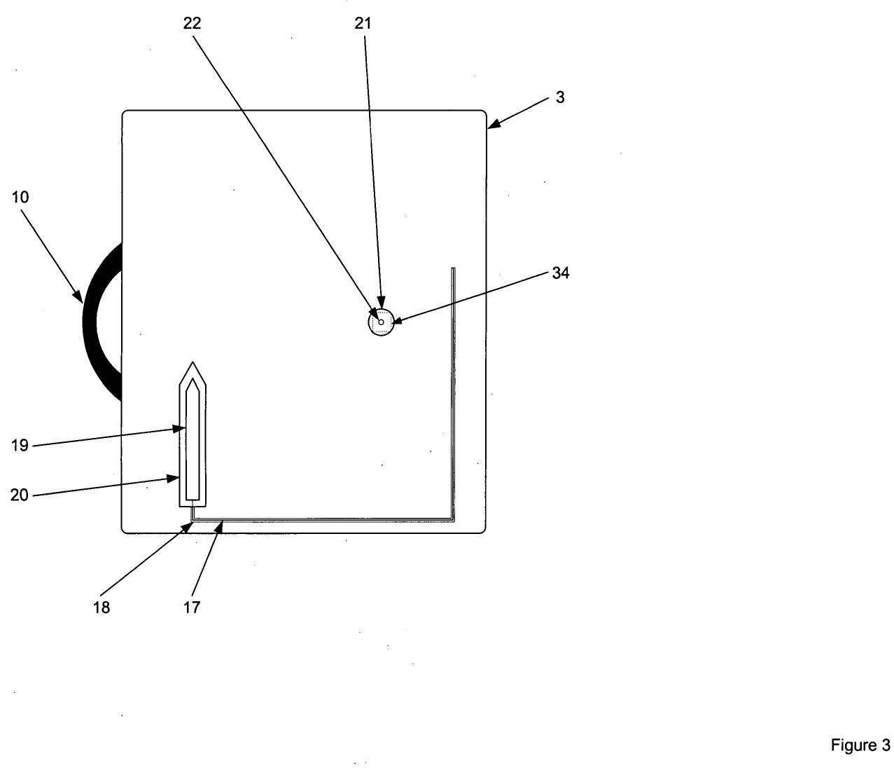

Upon originally opening the Lab 32, and opposite the right side described above, the user will see, among other things, a round-shaped depression called the identification tag pocket 21 in which to place one of the identification tags 4 (FIG. 3).

A. Identification tags 4 and tag identification pocket 21

1. Function.

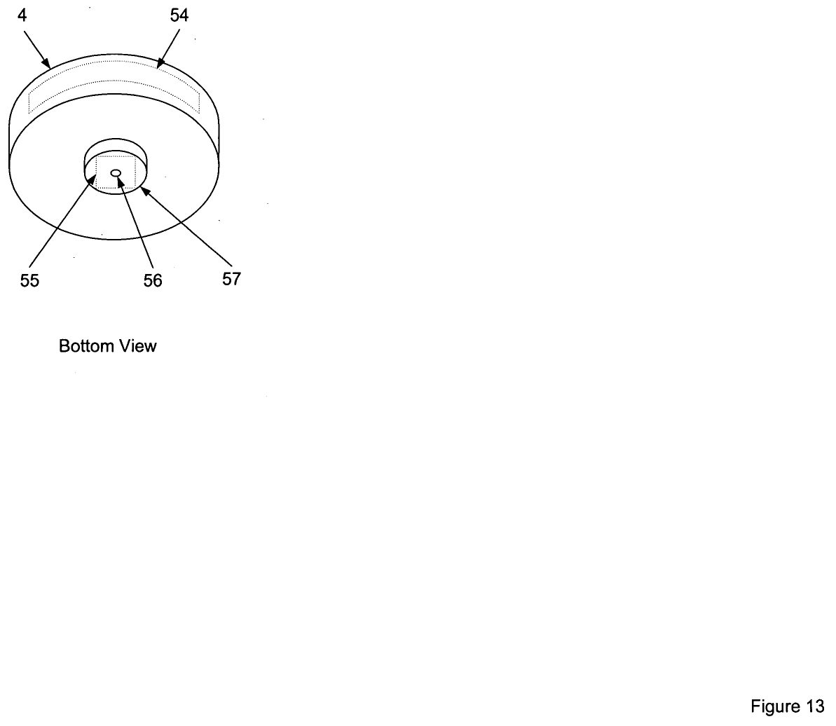

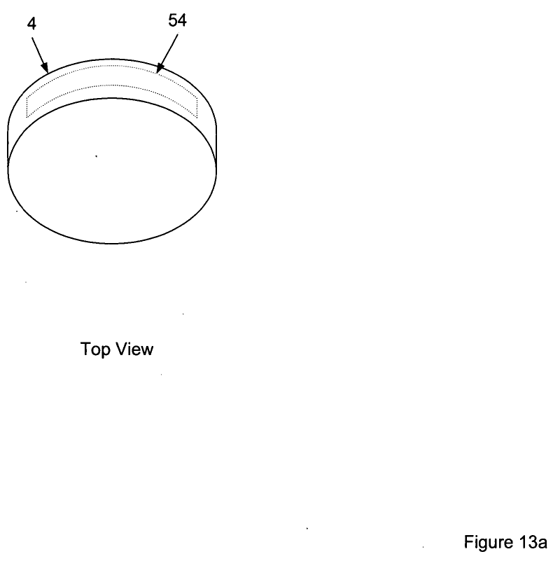

Each classroom setup, (which often includes 6 lab units) will receive many brightly colored molded plastic identification tags 4 by which the software can differentiate students (FIG. 13). Each student is assigned his own identification tag 4, which is housed in a drawer for identification tags 28 in the storage tower 24. Each identification tag 4 varies in combinations of color and shapes molded into their surfaces. Additionally, a teacher can attach a picture of the child to, or write his/her name on the “name sticker location” 54 on a particular identification tag 4, so that the child knows which one “belongs” to him/her. When an identification tag 4 is placed in the identification tag pocket 21, the lab unit will note which child's name has been assigned to that particular identification tag 4, then select appropriate lessons from its database for that child.

2. Tag reader description/construction.

Each identification tag 4 contains one-half of an RFID system; the receiver half (as is known in the art and not shown) of the system is located beneath the identification tag pocket 21 (FIG. 3). The identification tag's 4 transmitting microchip (as is known in the art and not shown) is located on a circuit board inside the identification tag's mating component 57. Immediately behind the plastic forming the surface upon which the identification tag is placed for reading, is a small RFID circuit board 52 containing the RFID receiver (not shown). The RFID circuit board 52 is less than one inch square and contains the RFID receiver integrated circuit as is known in the art and not shown. This unshown receiver is constantly radiating a 13.56 MHz magnetic field from the RFID tank coil 53 composed of a small, unshielded ferrite bobbin inductor and capacitor, as are known in the art and not shown. The receiver radiation induces a current in another tank within the identification tag 4 consisting of a coil etched on the circuit board 52 and a capacitor (unshown). The RFID integrated circuit (not shown but location in identification tag 4 shown in FIG. 13) within the identification tag 4 converts this current into the power necessary to operate and then re-radiates some serial data unique to that identification tag 4.

The circuit board within the identification tag 4 is less than three quarters (0.75) inches square and contains the RFID tag integrated circuit as is known in the art and not shown. (For the RFID circuit board location 55 in the identification tag 4, see FIG. 13.) The receiver integrated circuit receives this serial data and transmits it to the microcontroller (as is known in the art and not shown) through one of its general-purpose input/output ports configured as an asynchronous serial port.

A small “identification LED” 22 is located in the base of the identification tag pocket 21 to allow the software to draw the student's attention to place his tag in the pocket. The tag pocket 21 is built directly above the RFID reader circuit board (not shown but location 34 shown in FIG. 13) which is attached to the outside cover of the Lab 32. There is a hole for the LED 56 in the mating component 57 of the identification tag 4 which prevents the identification tag from contacting the slightly protrusive identification LED 22.

The preferred RFID system is made by Sino Matrix Technology, Inc. 3F-5, Sec. 1, Kwan-Fu Rd., Hsinchu City 300, Taiwan, R.O.C. 886-3-564-0786. The receiver (unshown but known in the art) on the RFID Circuit Board 52 part number is HL5233. The tag chip 45 part number is HL5230.

B. Stylus 19

1. Stylus 19 Function.

The Stylus 19 is the means used by the student to contact the surface of the touch screen 39 giving the user the impression he/she is writing on the LCD panel 40. Contact with the touch screen 39 gives the lab unit ability to collect constant “output” from the user, to determine whether or not the user is comprehending the concept being taught.

2. Stylus construction/description.

The injection-molded stylus 19 is also housed in the left side of the Lab 32 (FIG. 3) in the stylus storage pocket 20. The stylus 19 is preferably approximately ½ inch in diameter and 4 inches long, and is attached to the lab unit by a long, durable stylus lanyard 17 which is stored in the lanyard storage groove 18, a lengthy molded depression on the left-hand side of the Lab 32.

III. Wireless Local Area Network Radio

1. The lab units themselves preferably contain approximately 1 Mb of SRAM and approximately 1 MB of flash memory, but each unit communicates with the teacher's personal computer 44 known as the “host computer” via a wireless local area network, (WLAN), thus utilizing the much larger memory and capabilities of the host. The SRAM is used for temporary program, sound and image files storage. This data is received by the wireless network module as required and then discarded after use. The Flash memory, being non-volatile is used to store data that is needed independent of the network, such as the programming that is used to initiate contact with the network host, simple 1-person games, etc.

2. WLAN description/function.

The WLAN transceiver, (as is known in the art and not shown, but has a location 37 shown in FIG. 4 by dashed lines) is housed within the lab unit case and communicates with the teacher's personal computer 44 preferably via a USB Bluetooth dongle 13, i.e., a radio transceiver attached to the teacher's personal computer's 44 USB port. The teacher's personal computer 44 may or may not have a wireless network card installed so a USB Bluetooth dongle 13 will be provided. The wireless network dongle, preferably a Bluetooth Dongle 13, is a small plastic box the size of a human thumb with an integrated USP plug, and will connect to the teacher's personal computer 44 USB port and will be automatically recognized by the Windows operating system.

IV. Internal Power of Each Lab Unit

Each Lab 32 is powered by a rechargeable battery as is known in the art and not shown. The battery (not shown) is charged by replacing it each evening in the storage tower 24. The rechargeable power preferably emanates from several nickel cadmium or nickel metal hydride cells connected in series to provide the required operating voltage. Enough battery capacity is provided to allow the Lab 32 to operate continuously for several hours without recharging. These cells are re-charged with current from the charging coil as is known in the art (not shown but charging coil location 36 shown in FIG. 4) and can be recharged within a few hours by placing the Lab 32 into the storage tower 24.

V. Classroom Storage Tower 24

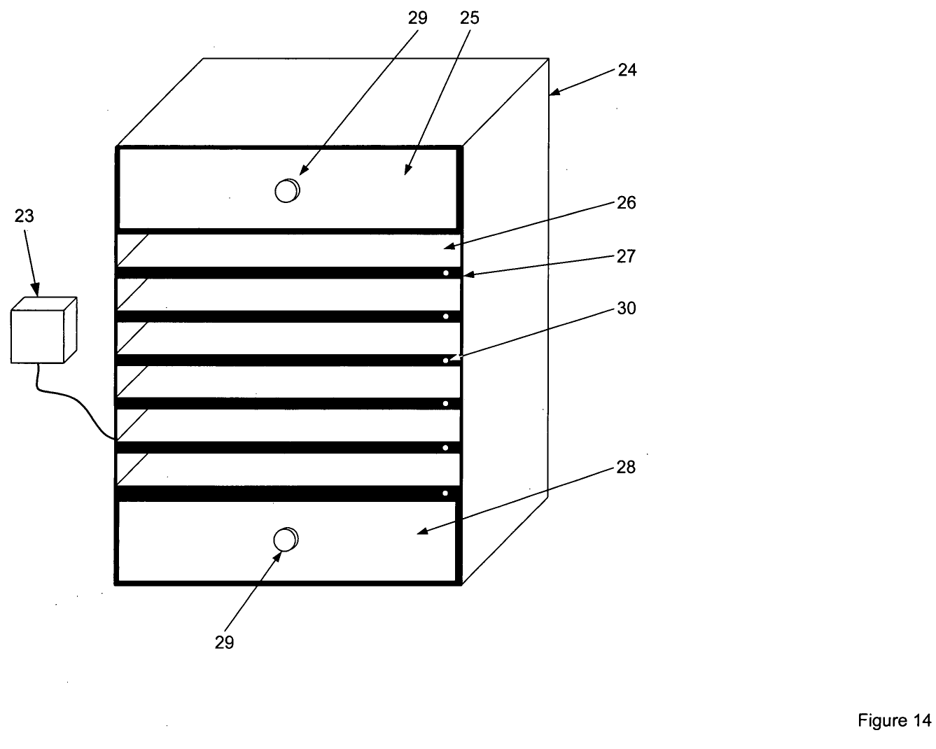

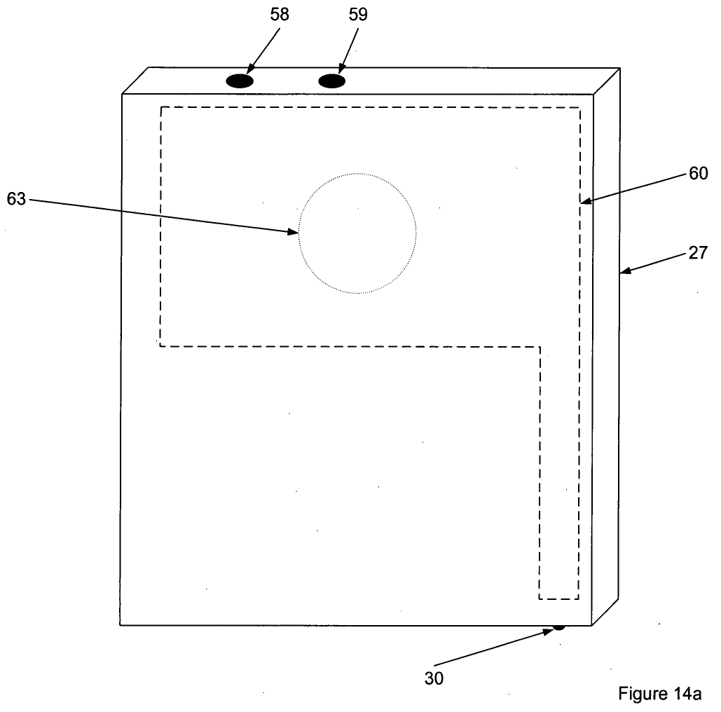

The storage tower 24 is preferably made of laminated fiberboard and is built to house each of the Lab 32 units while they are not being used and while they are charging (FIG. 14). When viewed frontally, the tower has a top drawer 25 for headphones 9 above six or more narrow horizontal shelves called charging/storage slots 26, all of which are placed above a bottom drawer 28 for identification tags 4. The six or more charging/storage slots 26 will house the six or more Labs 32 provided for each classroom. By pulling a drawer pull 29 the teacher can open either the top drawer 25 for headphones 9 or the bottom drawer 28 for identification tags 4 as needed for storage.

Inside the storage tower 24 is a charging system to recharge the lab units while not in use The charging system consists of two major parts: charging pads 27 attached to a circuit board (not shown but circuit board location 60 shown in FIG. 14a) in each charging/storage slot 26 and the charging coil (as is known in the art and not shown but location 36 shown in FIG. 4 within each Lab 32). There is a similar charging coil (not shown although charging coil location 36 shown in FIG. 4) inside each Lab 32. When a Lab 32 is placed properly on a charging/storage slot 26, the coils (not shown) in both slot 26 and Lab 32 line up, the charging indicator LED 30 lights up and a current is induced in the Lab 32 coil (not shown but charging coil location 36 shown in FIG. 4). The current is processed and used to charge the Lab battery, as is known in the art but not shown. The power to operate the storage tower 24 with its charging pads 27 comes from an off-the-shelf power charging transformer plug 23.

The charging transformer plug 23 connects with the storage tower 24 via a power input connector 58. After the charging transformer plug 23 is connected with one of the charging/storage slots 26, that slot's power/signal output connector 59 is wired in a “daisy chain” to each of the other five charging/storage slots' 26 power/signal output connectors 59, thus spreading the power from the charging/storage slot 26 connected to the charging transformer plug 23 to the other charging/storage slots 26.

VI. Software

Specially developed software controls every function of the lab unit, including “host application software” and software internal to the lab unit itself. Initially, when a teacher is introduced to the system, he/she will first be assisted by the host software to input each of her students' names into the system database. Thereafter, if the teacher does not pre-empt it, the host software will lead each student through the entire sequence of lessons ranging from ear-training and phonemic awareness through fluency and comprehension. However, should the teacher desire, she will have the option of placing a student any where on the lesson continuum she selects.

VII. Use of the LitLab Unit of the Invention

A. Unique Teaching Method using the LitLab including Lettered Tiles

Following are examples of the methods for use of the literacy-related lab unit of the invention to develop reading skills of students, which are not to be construed as limiting the invention.

### BACKGROUND

To be successful readers and writers, students must develop completely accurate mental images of the correct spelling of words. Initially, it must be noted that pronunciations of words form critical anchors for written words. But mental images of words can occur only when students make explicit connections between the individual sounds of spoken words and the letter or letters that represent each of the individual sounds within words. Then, the student must also connect the individual sounds and letters with word meanings, and store these sound-letter-meaning connections in their long-term memory.

A highly effective way to establish these critical images of words in long-term memory is thus through 1) explicit instruction in mapping letters to sounds, 2) careful examination of the letters that make up the spelling of words, and 3) multiple opportunities to read and spell words.

The teaching method of the invention being described at this instant comprises an individualized system that creates perfect mental images of words and facilitates their storage in long term memory through repeated exposures to those words under direct instruction and through independent experimentation. The present claimed invention is an improvement over the prior art in that it employs specific teaching methods coupled with technology for implementing the methods.

The specific teaching methods demonstrated immediately below create explicit connections between the individual sounds of spoken words and the letter or letters that represent each of the individual sounds within words, then further connects these letter-sound representations to word meaning, thereby imprinting complete and accurate mental images of words in a student's long-term memory. The method and apparatus of the invention being discussed in this section are used to teach, reinforce and assess reading and spelling skills.

In the Teaching Methods presently described, the LCD/touch screen and speaker in combination with the letter tiles are used to continuously gauge student understanding of aural/visual instruction by requiring ongoing “response/output” from the student during various activities. Initially incorrect “response/output” results in audio and/or visual assistance being given the student by the unit to lead her to the correct response. Initially correct “response/output” results in the unit providing commendation, then presenting different activities in a skill area until all activities in that skill area are completed.

Three types of unique teaching methods using the Lab to develop completely accurate mental images of correctly formed words follows:

1. An Initial Letter Tile activity allowing Student Discovery

2. Letter Tile Lesson Level One: Directed Instruction Spelling

3. Letter Tile Lesson Level Two: Independent Spelling of known words/assessment

1. Initial Letter Tile Activity: Student Discovery

Initially, the literacy-related invention provides opportunity for independent experimentation, e.g., the student is allowed to select and combine letter tiles of his own choice to form correctly-spelled words of three or four letter lengths. Other versions of the Lab allow spelling of words longer than 4 letters and shorter than 3 letters.

Following are examples of the method of the invention. Examples of speech phrases presented are for example purposes only, and it is clear that other phraseology may be used different from that given below without departing from the spirit and scope of the invention herein. When the examples indicate that the “Lab” voice is speaking, this is accomplished by downloading program segments over the “wireless local area network radio” containing both audio and matching digital video images viewed as the LCD screen. Before the student responds correctly or incorrectly to the instruction given, the unit has already downloaded and retained in its memory the next possible audio/video segments. Once the student responds to the instruction, the unit can thus seamlessly reply by providing appropriate direction, whether commendation or correction.

For example, a student may be asked to select tiles as follows. Lab: “Now, let's spell words. Please look at the letters above the screen and pick up any tile to start your word. Place it in the pocket with the red light flashing around it.” The student can pick any letter to begin his word (except “x”, since there is no 3 or 4 letter word beginning with that letter). If the student chooses and places the letter tile with an “x” on it in the reader pocket, the Lab will say a statement such as: “I don't think there are any three or four letter words that start with an ‘x’. Please choose another letter”. But if the student should choose, for example, the letter “b” and place it in the left-most letter-reader pocket, (recall that in one version of the LitLab there are four reader pockets contiguously placed on the face of the Lab where tiles can be placed by the student and identified by the unit), the Lab will say: “Good choice; now choose a second letter”. Simultaneously the lighted green bar across the base of the left-most reader pocket will come on and stay on.

If the student selects as a second letter, for example, a tile with a letter (such as “q”) which does not form a valid combination with b to form a 3 or 4 letter word, e.g. “bq”, after the Lab rapidly scans its vocabulary of words beginning with “b” and finding no word that begins “bq”, the Lab says: “Choose another letter tile, since there are no three or four letter words that begin with the letter ‘b’ followed by a ‘q’”. But if a student selects and correctly places into the second tile-reader pocket a second letter which forms a valid beginning to a 3 or 4 letter word (such as the “a” letter tile), the Lab will say: “Good choice! Now choose a third letter to form a word” Simultaneously as the verbal commendation is given, the green-lighted bar under the second letter-reading pocket will come on and stay on, confirming as correct the student's experiment thus far.

If the student chooses a third letter (such as “z”) which in combination with the first two does not correctly form a valid word as stored in the lab unit software, the Lab will say: “That letter does not combine with ‘b’ and ‘a’ to correctly spell a real English word. Try another letter, please.” But if the student selects a letter which does complete a correctly-spelled three letter word, the Lab will give commendation while brightly lighting the chosen letters for three seconds in order to reinforce the correct spelling of a word saying: “Excellent!, you created the word ‘bat’.” Simultaneously, reward music will play and an appropriate picture will appear in the LCD screen, (in this case a bat with flapping wings).

The Lab will also simultaneously query its database of four letter words using the same first three letters as in bat, saying if appropriate: “If you add one more letter to the end of the word, you can form another different word. Try putting another letter at the end of the word in the pocket that is lighted.” If the student then selects either and “h” or “s”, (forming the words “bath” or “bats” respectively), the Lab will give appropriate praise. If the student does not select either and h or an s, but tries other letters unsuccessfully two times, the Lab will say: “Why don't you try putting the letter h after the word you have spelled to spell a new word.” If correctly completed as suggested, the Lab says: “Great! You spelled the word bath. Let's start over again.”

2. Letter Tile Lesson Level One: Directed Instruction Spelling

In the previous example, the student was allowed to experiment on his/her own to form words using lettered tiles. In this example, describing the first level of direct instruction lessons using the tiles, (as opposed to the student discovery method discussed previously), the student is explicitly shown by the Lab, in a letter by letter sequence, how to begin mapping sounds to letters, thence to word meaning. For example, The Lab says: “Let's spell the word ‘bat’. Let's begin by sounding out the word: /b/-/a/,-/t/.” The corresponding letters are printed on the LCD screen as each sound is spoken. The Lab then says: “The word ‘bat’ has three sounds. The first sound is /b/. Pick up the letter that spells the /b/ sound in “bat” and place the letter in the letter pocket with the flashing light.” The appropriate letter is printed on the LCD screen while the student searches for it. Additionally, the appropriate letter-reading pocket is bracketed with red light bars to direct the student's attention to a particular pocket, in this case the left-most pocket.

When the student completes that task, the /b/ sound will be spoken and a green LED light bar under that tile-reader pocket will come on and stay on, giving the student audio and visual support that he is on the right track. The Lab continues: “Good, now let's pick up the letter that spells the /a/ sound in “bat” and put it into the next pocket.” The letter “a” flashes slowly on the LCD screen while red bracketing LED's come on, directing the student's attention to the pocket which is second from the left.

After correctly completing that task, the /a/ sound will be spoken and the green LED light bar under the second pocket will come on and stay on, matching the green light bar under the first tile-reader pocket.

The Lab will continue saying: “Great, now let's pick up the letter that spells the /t/ sound in “bat” and put it in the next pocket.” The letter “t” flashes slowly on the screen; bracketing lights surround the third pocket from the left. After the student places the “t” tile in the proper pocket, the /t/ sound will be spoken and then the selected letter tiles will brightly glow for approximately three seconds as feedback for the correct response.

The Lab then says “Excellent work! What does that word spell? Now look at the pictures (e.g., a dog, a cat, a bat) on the screen. Please pick up stylus and touch the picture of the word we just spelled.” If the student does not touch the picture of a bat, the Lab will assist the student to select the picture of the bat.

Once the student correctly touches the picture of a bat on the screen, appropriate approval will be voiced by the Lab, the word “bat” will be placed in that student's file of completed words which will be reviewed at least one more time in later lessons, and the student will be directed to spell another word. Thus the student mapped each sound of the word “bat” to its corresponding letter, then made a connection with the word meaning, thereby beginning to establish the mental image of the word “bat” in long term memory. Repeated exposure to the word, with explicit mapping of letters to sounds then connecting properly juxtaposed letters to word meaning establishes a more robust mental image in long term memory. The Lab will expose each student to at least three presentations of each word taught, giving him/her repeated experience in mapping letters to sounds, then associating correctly combined sound symbols to word meanings.

3. Letter Tile Lesson Level Two: Independent Spelling of Known Words/Assessment

In the previous Level 1 type of lesson, a student maps the letter sound to alphabetic symbols and word meanings under direct, systematic instruction. In a Level 2 type tile lesson, as demonstrated in the following example, the Lab promotes the student's independent application of this critical spelling strategy. Should the student exhibit an incorrect response, the Lab provides immediate corrective feedback. Should the student correctly spell a word on first attempt, that word will be placed into the “Review Only” database for that student.

For example, the Lab asks the student: “Show me how to spell the word ‘bat’. The first sound is /b/. Put the letter that spells the /b/ sound in the first letter pocket.” For any letter tile selected by the student and placed in the pocket that is not a “b” tile, the Lab says: “That's not the letter we were looking for. Pick up the letter ‘b’ and put it in the pocket.” Simultaneously with this instruction the letter “b” appears on the LCD panel to direct the student. After the student selects the “b” tile and places it in the correct pocket, the Lab says: “Great!, The next sound is /a/. Put the letter that spells the /a/ sound in the next letter pocket.” This sequence continues in that manner of direct instruction until the word is correctly spelled.

If the student does not correctly spell the word requested, that word is replaced in that student's data base for further re-exposure. If the student does spell the requested word, that word is placed in the Review Only data base for that student.

Thirty days after a word has been placed in the Review Only data base, (for words previously correctly spelled by the student), those words will be re-introduced for review in an alternating sequence with words the student has never correctly spelled in a Level 2 Lesson.

In summary, the Teaching Method discussed in this section involves a unique hardware/software platform, connected by WLAN radio to a computer (but without using its monitor), presenting a teaching method using lettered tiles, an LCD panel/touch screen and stereo speakers to assist students to form completely accurate mental images of correctly spelled words. Additional embodiments of this method not discussed specifically above, but clearly contained within the method of the invention as noted above are learning systems assisting students to create words of lengths varying from 1 letter to 8 letters.

B. Unique Teaching Methods Using the Quantum Lab and Numbered Tiles

Following are examples of the “method of the invention”, i.e., for using the lab unit of the invention, (math version called “Quantum Lab”), to develop math skills of students, which is not to be construed as limiting the invention. Young students can receive needed repetition from the unit in explanation of concepts related to numbers, measurement, geometry, algebra, probability as well as repetition in practicing math operations.

1. Hardware

The math unit is virtually identical in all physical and functioning aspects to the literacy unit, (including the LCD screen, touch panel and speakers), but with different tiles, and a different number and configuration of the tile-reader pockets on its face. The math unit substitutes numbered tiles and operation signs for letter tiles. Versions of the unit for the youngest students will consist of tiles bearing both Arabic numerals and corresponding dot patterns, facilitating understanding of the sense of each number. The version for younger students will only allowing students to perform operations with single integer numbers.

Embodiments of the unit for older students will vary only by providing both a higher quantity of arabic number tiles and also more tile-reader pockets, thus providing full practice in two-integer number operations including addition, division, multiplication and division, as well as practice in fractions and decimals.

2. Software,
a. Generally

Math lessons are presented aurally and visually by the software driving the unit's LCD screen/touch panel and speakers. The lessons are developed as several sequential series covering number sense, measurement, geometry, algebra and probability. Initially incorrect “response/output”, results in audio and/or visual assistance being given the student by the unit to lead her to the correct response. Initially correct “response/output” results in the unit providing commendation, then presenting different activities in a sub-skill area until all activities in that entire skill area are completed.
b. Skill areas

Since Kindergarten math students are required to master the following skill areas: Numbers, Measurement, Geometry, Algebra and Probability, multiple lessons involving both number tiles, the LCD panel/touch screen and speakers are provided.

Three types of unique teaching methods using the Lab to develop a student's math skill regarding numbers sense are demonstrated as follows

1. Initial number tile activity allowing student discovery

2. Number Tile Lesson Level One: Directed Instruction to build equations

3. Number Tile Lesson Level Two: Independent Math operations/assess

1. Initial Number Tile Activity Allowing Student Discovery

Exactly as in the initial letter tile activity allowing student discovery set forth above, the student is allowed to freely experiment with number operation tiles to form conclusions, i.e., the software asks the student to first choose any numbered tile and place their choice in the tile-reader pocket on the farthest left side of the Lab. (See FIG. 2a Quantum Lab) The choice selected is also shown on the LCD screen below the tile-reader pockets. Next the Lab asks the student to select an operation tile from those provided, (e.g., either =, −, ×, or division signs), then place their choice in the operation reader pocket. Again that choice is also shown on the LCD screen below the reader pockets. The student is then asked to select a second number tile and place that choice in the pocket after the operation sign but before the equal (=) sign.

The student is then allowed a certain number of chances to choose the correct number resulting from such equation. If answered correctly, the student is given commendation and further opportunities to explore. If answered incorrectly, the LCD screen will provide graphic pictorial assistance to arrive at the correct conclusion.

2. Letter Tile Lesson Level One: Direct Instruction to Build Equations

In an example of a direct instruction math lesson covering the basic operation of addition, the software would ask the primary grade student to select a particular numbered tile, ( perhaps the number “2”) and place it in the tile reader pocket furthest to the left, (a light surrounding that pocket flashes slowly to attract the student's attention. The LCD panel will display the number 2 being sought both with its arabic symbol as well as with various countable objects such as two apples to assist the student. The student is then requested to pick the operation sign for addition: “+” and place the sign in the “operations pocket”, (while the light surrounding the operations pocket flashes slowly to attract the student's attention).

The student is then asked to select another particular numbered tile, (for example the number “3”) to complete the left side of the equation and place that tile in the appropriate pocket. The light tube surrounding the pocket preceding the = sign is flashing, while both an arabic and graphic picture (such as three more apples) are shown on the LCD panel.

The student is then asked to find the numbered tile that would correctly solve the equation “2+3=5”. If he selects the correct numbered tile, he receives award music, a commendation and proceeds to further equations. If incorrect after two tries, he will be given a demonstration by the software showing him how to add apples to reach the sum.

3. Number Tile Lesson Level Two: Independent Math Operations/Assess

As an example of this lesson type, a student will be asked to simply solve an equation such as “What is the sum of 4 ants+4 ants”, “What is the remainder if 2 ants leave from a group of 6?”, etc. In this example, the correct number of ants would be shown on the LCD panel underneath each arabic number to give clues and reinforcement to the student on the concept being taught. As always correct answers lead to exploration of further examples; incorrect answers lead to further instruction on the example under consideration.

C.Unique Teaching Method Using the Lab to Teach Phonological Awareness.

In this Method and those that follow, the software of the literacy-related unit, driving the unit's LCD panel/touch screen and speakers, is used to provide a unique opportunity to enhance a student's literacy-related skills. In this Method particular focus is given to increasing the “phonological awareness” of students, e.g,., the ability to recognize that sentences consist of words, words of syllables, and syllables of individual phonemes, the smallest unit of spoken words, concepts of “beginning, middle and end”, etc.

In this Teaching Method, the LCD/touch screen is used to continuously gauge student understanding of aural/visual instruction by requiring ongoing “response/output” from the student during various learning activities. Initially incorrect “response/output”, as demonstrated by the student touching any area on the touch screen other than that designated through software as the “correct response area”, results in audio and/or visual assistance being given the student by the unit to lead her to touch the correct response area. Initially correct “response/output” results in the unit providing commendation, then presenting different activities in the sub-skill area until all activities in the phonemic awareness skill area are eventually completed.

The Method provides instruction and practice building phonological awareness with multiple lessons/activities using specifically the LCD panel/touch screen and speakers to focus on each of the following sub-skills:

1. segmenting sentences into words,

2. segmenting words into syllables,

3. segmenting syllables into phonemes,

4. manipulating phonemes,

5. blending sounds and

6. blending syllables,

7. distinguishing between rhyming and non-rhyming words,

8. identifying and discriminating vowel sounds.

9. other phonologically-related skills

An first example using the Lab in a unique teaching method to improve a student's ability to segment sentences into words now follows. The unit will first ask the student to touch the screen to demonstrate that he is holding the stylus and ready for the activity. The software will then present a simple sentence on the LCD panel, i.e., printing the words “The man fell.” on screen. In the right corner of the panel a checkered flag is unfurled.

The student is requested to tap the screen, using the stylus, the number of times corresponding to the number of words in the sentence (which, in the example given, has three words) then touch the checkered flag in the screen corner if finished. If the student were to tap the screen three times then touches the flag, rewards sounds and graphics of a car reaching the finish line would be shown.

If the student incorrectly tapped either too many times or not enough times, the software would provide explicit assistance, such as: “Nice try. ‘The man fell’ has three words. We were looking for three taps. Let's try another sentence.” If the student fails to tap at all, the unit will give him cues to get him active, then, if unsuccessful in securing any response will begin the daily close-down sequence.

Another, second example using the Lab to teach phonological awareness involves the use of color tiles to be manipulated as “place holders” to represent the number and sequence of individual sounds in a spoken word, e.g., the Lab asks the student to place in the tile reader pockets the same number of colored tiles as there are phonemes in the word “belt”. Since there are four phonemes in the word, the student will be assisted to place four variously colored letter tiles in the tile-reading pockets. The Lab may then present the word “melt” and ask the student which colored tile should be replaced if we change the word “belt” to “melt”. If the student selects the colored tile in the first tile-reading pocket, commendation will be given. If the student chooses any other tile to complete the task, assistance will be provided to lead the student to the correct tile.

D. Unique Teaching Method Using the Lab to Teach Phonics and Decoding

In this Teaching Method, as in those above, the software of the literacy-related unit, driving the unit's LCD panel/touch screen and speakers, provides a unique opportunity to enhance a student's knowledge related to “phonics and decoding”.

In this Teaching Method, the LCD panel/touch screen is used to continuously gauge student understanding of aural/visual instruction by requiring ongoing “response/output” from the student during various lessons/activities. Initially incorrect “response/output”, as demonstrated by the student touching any area on the touch screen other than that designated through software as the “correct response area”, results in audio and/or visual assistance being given the student by the unit to lead her to touch the correct response area. Initially correct “response/output” results in the unit providing commendation, then presenting different activities in the phonics/decoding sub-skill areas until all activities in that entire skill area are completed.

The Method provides instruction and practice building phonics and decoding skills by presenting multiple lessons/activities using the LCD panel/touch screen focusing on each of the following sub-skills:

1. Identifying letters and letter sound relationships,

2. Blending letter-sounds to read words, (alphabetic principle)

3. Identify and practice blending consonants

4. Identify and practice using long vowels, diphthongs, digraphs and r-controlled vowels

5. Using common letter patterns to read words

6. Using structural cues to read words

7. Other skills related to phonics and decoding

An example using the Lab in a unique Teaching Method to teach phonics follows. Lessons have been developed assisting the student to identify letter sound relationships. In such example, the software will begin a certain lesson by dividing the screen into thirds. In the left third the LCD panel shows the letter “s” while the software directs the speaker to say: “Letter ‘S’ says /s/ as in ‘sun’ . . . and ‘soap’. When the word ‘sun’ is spoken, the /s/ sound is drawn out for emphasis and a picture of a sun appears on the LCD panel in the middle third. When the word ‘soap’ is spoken, a picture of a bar of soap appears in the right third of the panel.

Then, a dog appears on screen from the left edge of the LCD panel walking in front of, then standing and obscuring the letter ‘s’ on the leftmost third of the screen. The software says: “Hmm, there's a dog. What is he doing there; there is no ‘s’ sound in the word dog, is there? Let's look at some more pictures”. The three different pictures whirl in circular fashion on screen, then coming to rest, one picture inside each of the three panel divisions. “Now touch the picture of a word that has the ‘s’ sound in it.” Appropriate feedback will be given depending on touches made by the student on the screen, either praise for correct touches or assistance to reach the correct conclusion.

When the student correctly selects a picture, the corresponding printed word is displayed with the letter ‘s’ highlighted in the word.

E. Unique Teaching Method Using the Lab to Teach Fluency

In this Method and those that follow, the software of the literacy-related unit, driving the unit's LCD panel/touch screen and its speakers, provides a unique opportunity to enhance a student's literacy-related skills particularly focusing in this Method on “fluency” skills of students, e.g,., their ability to effortlessly/automatically recognize certain words, then read such words with correct expression.

In this Teaching Method, the LCD panel/touch screen is used to continuously gauge student understanding of ongoing aural/visual instruction by requiring constant “response/output” from the student during various activities. Initially incorrect “response/output”, as demonstrated by the student touching any area on the touch screen other than that designated through software as the “correct response area”, results in audio and/or visual assistance being given the student by the unit to lead her to touch the correct response area. Initially correct “response/output” results in the unit providing commendation, then presenting different activities in a sub-skill area until all activities in that entire skill area of fluency are eventually completed.

The Method provides instruction and practice in increasing students' reading fluency ability by presenting multiple lessons/activities using the LCD panel/touch screen concerning, but not limited to, each of the following sub-skills

1. unscrambling letter combinations to form correctly spelled words.

2. After listening to a sentence, selecting the correct spelling of key words from various similarly spelled choices.

3. Word flashing, measuring time taken to identify the word, then progressively shortening that time until “automaticity” is reached.

4. Sentence flashing, progressively shortening recognition time.

5. Recognizing incorrectly expressed sentences

6. Other sub-skills associated with spelling and writing skills

An example of a unique teaching method using the Lab to improve a student's fluency ability follows.

“Automaticity” is the ability to recognize letter patterns effortlessly, particularly words that appear in the language with high frequency yet do not correspond to the phonics ‘rules’, e.g., words such as “the”, “said”, “father”, “me”, “find”, “saw”, etc. Acquiring automaticity for any words requires repeated exposure to those words.

Example of unique method:

After preliminary phonics rules have been taught and mastered previously such as those pertaining to CVC words, blends, long vowels, etc.) the software introduces an activity to teach automaticity for a single word, for example “said”, pulled from its data base of several hundred high frequency words. Displaying it on the LCD panel, the software shows the target word, then uses the word in a spoken sentence:

### “He said we could watch TV.”

The software asks the student to use the stylus to touch each letter in the word “said” and to carefully examine the spelling of the word before it is removed from display. If each letter is correctly touched the word begins to slowly blink on screen then fades away.

The student is then asked to play a ‘game’ to unscramble letters displayed on the LCD screen to correctly spell the target word. The number of attempts it takes for the student to correctly unscramble the word “said” is recorded. Until the student accomplishes the task in a single attempt, the word remains in that students' data base for repetition.

The student continues through a random selection of words from that activities' database until 4 minutes and 30 seconds have elapsed, only introducing new words until that point. After 4:45 seconds, no matter where the student is in the exercise, the software ends the lesson segment with the activity character saying: “Oops, its time for us to move on to our next activity.”

The excess seconds unused in that lesson segment are temporarily tracked allowing the aggregate time remaining after 3 five minute lesson segments to be used in the final “game time” segment at the end of the daily lesson. The entire time spent on the daily lesson should not exceed 20 minutes max, including 3 five minute lesson segments and game time at end. Game time could be completely ignored by the student if the student chooses to end a session at lesson conclusion.

F. Unique Teaching Method Using the Lab to Teach Vocabulary

In this Method and those that follow, the software of the literacy-related unit, as presented through the unit's LCD and touch screen technology, are used to provide a unique opportunity to enhance a student's literacy-related skills particularly focusing on building student vocabularies.

In this Teaching Method, the LCD panel/touch screen is used to continuously gauge student understanding of aural/visual instruction by requiring ongoing “response/output” from the student during various activities. Initially incorrect “response/output”, as demonstrated by the student touching any area on the touch screen other than that designated through software as the “correct response area”, results in audio and/or visual assistance being given the student by the unit to lead her to touch the correct response area. Initially correct “response/output” results in the unit providing commendation, then presenting different activities in a skill area until all activities in that skill area are completed.

The Method provides instruction then, practice building a student's vocabulary by presenting multiple lessons, (not limited to the following), in vocabulary sub-skills such as

1. Matching words with various pictures

2. Labeling pictures of objects with correct names from various choices

3. sorting nouns and verbs

4. Using word meanings to spell compounds, homophones

5. other skills related to developing vocabulary

An example of this teaching method using the Lab to teach compound words follows. The software presents three pictures across the top half of the screen:

### Butter hat fly

In the bottom half of the screen the software presents three empty boxes from left to right. Between the first two boxes is a plus sign “+”; between the middle and right boxes is an equal sign “=”. The software slowly “drags” the picture of butter into the left-most box. The student is asked to “drag” (by using the stylus) either remaining picture into the middle box to form a compound word. If the student selects the hat, the software says, “Is there such a word as ‘butterhat’? We were looking to add ‘Butter’ and ‘fly’ to make a new compound word ‘butterfly’”. As the word fly is pronounced, the software drags the picture of the fly into the middle box, then a butterfly waves its wings as it appears in the right-most box and flies away.

G. Unique Teaching Method Using the Lab to Teach Writing and Spelling Skills

In this Method, the software of the literacy-related unit, driving the unit's LCD Panel/touch screen and speakers, provides a unique opportunity to enhance a student's skills related to writing and spelling.

In this Teaching Method, the LCD/touch screen is used to continuously gauge student understanding of aural/visual instruction by requiring ongoing “response/output” from the student during various activities. Initially incorrect “response/output”, as typically demonstrated by the student touching any area on the touch screen other than that designated through software as the “correct response area”, results in audio and/or visual assistance being given the student by the unit to lead her to touch the correct response area. Initially correct “response/output” results in the unit providing commendation, then presenting different activities in each sub-skill area until all activities in the writing/spelling skill area are eventually completed.

The Method provides instruction and practice improving writing and spelling skills with multiple lessons/activities (using the LCD panel/touch screen and speakers) in each of the following subskills:

1. drawing shapes

2. writing capital and lower case letters

3. writing numbers

4. Spelling simple words

5. other subskills of spelling and writing

As an example of using the Lab in a unique Teaching Method to improve writing skills, it will be shown what happens when the unit teaches the student to write the letter A. After the software “writes” the letter in demonstration numerous times in the traditionally accepted stroke patterns, all pixels in the LCD screen would be turned “on”, making the screen appear completely “black”. Several pixels (perhaps 5 or more wide) will then be turned “off” leaving an outline of the letter A presented on screen.

The student will be asked to use the stylus to print the letter “A” within the outline of that letter shown on the screen. If the student should touch pixels outside the outline (which defines the acceptable pixels he should have touched to form the letter A), the software will record the image printed by the student, then determine if it comes within the acceptable range of permitted variation and either cause the student to repeat practicing that letter or, if the student was successful, continue to present other letters.

Additionally, the length of each portion of a figure (whether a letter, number or symbol) taught is calculated by the software as a certain number of pixels in a single stroke line necessary to properly form each portion of that symbol. Should the student touch only a few pixels on one portion of a letter, but remain inside the outline, the result would be an incomplete symbol although “inside the lines”. The software, as always, will record the student's incomplete work, calculate each portion of a figure requested as either “complete” or “incomplete”, then according to a fixed formula repeat the letter again or move to other letters, numbers or symbols.

While the invention has been described with reference to specific embodiments, it will be appreciated that numerous variations, modifications, and other embodiments are possible, and accordingly, all such variations, modifications, and other embodiments are to be regarded as being within the spirit and scope of the invention.

What is claimed is:

1. A teaching apparatus for students, comprising a lab unit having a top face, the lab unit comprising:
a) a plurality of manipulable indicator tiles, each tile having a character printing area containing an indication mark and having an identifier chip;
b) a plurality of tile-reader pockets on the top face;
c) a touch screen and stylus;
d) a liquid crystal display screen; and
e) a speaker,
wherein the lab unit can scan and recognize an identifier chip in an indicator tile placed in a tile-reader pocket, the student can receive graphic instruction via the liquid crystal display screen and receive verbal instruction via the speakers, and the student can demonstrate comprehension of tasks via the touch screen and letter tiles.

2. The teaching apparatus according to claim 1, further comprising headphones.

3. The teaching apparatus according to claim 1, wherein each indicator tile contains one-half of a radio frequency identification system and each tile-reader pocket contains a receiver half of a radio frequency identification system.

4. The teaching apparatus according to claim 1, wherein the lab unit further comprises wireless local area network technology.

5. The teaching apparatus according to claim 1, further comprising a teacher's host computer having a wireless local area network radio transmitter.

6. The teaching apparatus according to claim 1, wherein the lab unit comprises a rechargeable battery.

7. The teaching apparatus according to claim 1, further comprising a classroom storage tower.

8. The teaching apparatus according to claim 9, wherein the classroom storage tower comprises shelves for multiple lab units with a battery charging portion built into each shelf.

9. The teaching apparatus according to claim 1, wherein the indication mark is selected from the group consisting of letters of the alphabet, numbers, mathematical indicators, or other graphic symbols representing any language.

10. The teaching apparatus according to claim 1, further comprising identification tags and an identification tag pocket.

11. The teaching apparatus according to claim 1, further comprising unlabeled colored tiles.

12. A method for teaching students, comprising:
a) providing a teaching apparatus according to claim 1,
b) performing at least one of steps c)-e) with the lab unit, utilizing indicator tiles for positioning in tile-reader pockets, together with spoken instructions and spoken corrective feedback through the speaker combined with visual/graphic instruction shown through the liquid crystal display screen;
c) providing preliminary spoken and graphic instructions to students to allow each student to become familiar with the lab unit;
d) providing directed spoken and graphic visual instructions to students to direct them in exercises utilizing the manipulable indicator tiles; and
e) providing another series of spoken instructions to apply strategies to utilize the manipulable indicator tiles independently, wherein the instructions are given both graphically via the liquid crystal display screen and aurally via the speakers.

13. The method according to claim 12, wherein the instructions in step d) require the student to selects tiles and builds words or math equations, and the indication mark is a number or operations symbol.

14. The method according to claim 12, wherein the instructions in steps d) and e) are related to spelling of words, and the indication mark is a letter of the alphabet.

15. The method according to claim 12, wherein the instructions in steps d) and e) are related to phonological awareness, and the indication mark is a letter of the alphabet.

16. The method according to claim 12, wherein the instructions in steps d) and e) comprise instructions related to teaching fluency and comprehension.

17. The method according to claim 12, wherein the instructions in steps d) and e) relate to vocabulary.

18. The method according to claim 12, wherein the instructions in steps d) and e) relate to writing/spelling skills and the use of a stylus.

19. The method according to claim 12, wherein the instructions in steps d) and e) relate to reading skills.

20. The method according to claim 12, wherein the instructions in step d) and e) relate to phonics and decoding.
